(19) United States
(12) Patent Application Publication
(10) Pub. No.: US 2024/0419192 A1
(43) Pub. Date: Dec. 19, 2024

(54) SWARM ROBOT CONTROL SYSTEM FOR SAFETY INSPECTION AND SURVEILLANCE PATROL, AND OPERATING METHOD THEREOF

(71) Applicant: CASE LAB CO., LTD., Suwon-si Gyeonggi-do (KR)

(72) Inventors: Tae Yong KUC, Suwon-si (KR); Sung Hyeon JOO, Suwon-si (KR)

(21) Appl. No.: 18/273,997

(22) PCT Filed: Feb. 8, 2022
(86) PCT No.: PCT/KR2022/001912

§ 371 Date: Jul. 25, 2023

(30) Foreign Application Priority Data
Feb. 9, 2021 (KR) 10-2021-0018499
Mar. 4, 2021 (KR) 10-2021-0028589

(51) Int. Cl. G05D 1/69; G05D 1/221; G05D 1/246; G05D 1/644; G05D 105/00; G05D 105/40; G05D 105/85

(52) U.S. Cl. CPC G05D 1/69; G05D 1/221; G05D 1/246; G05D 1/644; G05D 2105/40; G05D 2105/57; G05D 2105/85

(57) ABSTRACT

A swarm robot control system for safety inspection and surveillance patrol, and an operating method thereof are disclosed. The swarm robot control system includes one or more management robots which are placed in each safety management area, and collect and transmit safety management data while traveling autonomously in a safety management area based on control command data, a local controller which is placed in each safety management area, and transmits the control command data to the management robot and receives the safety management data from the management robot, one or more relay robots which are placed in each safety management area, and move to a predetermined relay location so as to relay communication between the local controller and the management robot, a charging robot which is equipped with a rechargeable battery, and provides power for charging the battery to at least one of the management robot or the relay robot, and a central controller which receives the safety management data from the local controller in each safety management area and transmits the control command data to the local controller so as to remotely control the management robot.

### TECHNICAL FIELD

The present disclosure relates to a swarm robot control system for safety inspection and surveillance patrol, and an operating method thereof.

### BACKGROUND

The content described below merely provides background information related to the present embodiment and does not constitute the related art.

In construction sites, power generating plants, oil refining facilities, semiconductor and chemical plants, etc. where there are ever-present harmful factors such as hazardous gases, fires, explosions, and leaks, safety management is necessary at all times.

Generally, safety management is done by safety management personnel by patrolling the workplace. Direct safety management by safety management personnel relies on their working hours, there may be discrepancies depending on their skills, and a labor shortage can make it difficult to conduct thorough control. Thus, there is a need for an industrial safety management measure for conducting safety management at all times, independently from safety management personnel.

### Prior Art Document

(Patent Document 1) Korean Patent Publication No. 10-2007-0061213 (published on 13 June, 2007).

### SUMMARY

### Technical Problem

An aspect of the present disclosure is to provide a swarm robot control system and an operation method thereof which are able to increase the convenience of safety management by conducting safety surveillance and patrol in the workplace which are conventionally performed by safety management personnel.

Furthermore, another aspect of the present disclosure is to provide a swarm robot control system and an operation method thereof which support seamless communication connectivity between a management robot and a local controller by determining the location of a relay robot based on the location of the management robot.

### Technical Solution

An aspect of the present disclosure provides a swarm robot control system for safety diagnosis and surveillance patrol for each safety management area. The swarm robot control system includes one or more management robots which are placed in each safety management area, and collect and transmit safety management data while traveling autonomously in a safety management area based on control command data, a local controller which is placed in each safety management area, and transmits the control command data to the management robot and receives the safety management data from the management robot, one or more relay robots which are placed in each safety management area, and move to a predetermined relay location so as to relay communication between the local controller and the management robot, a charging robot which is equipped with a rechargeable battery, and provides power for charging the battery to at least one of the management robot or the relay robot, and a central controller which receives the safety management data from the local controller in each safety management area and transmits the control command data to the local controller so as to remotely control the management robot.

Another aspect of the present disclosure provides an operation method of a swarm robot control system including a management robot, a relay robot, a local controller, and a central controller. The operation method includes collecting, by the management robot, safety management data while the management robot travels autonomously in a safety management area based on control command data received from the local controller, selecting, by the relay robot, a relay location based on the location of the management robot, relaying, by the relay robot, communication between the local controller and the management robot after moving to the relay location, and receiving, by the local controller, the safety management data from the management robot and transmitting the safety management data to the central controller.

### Advantageous Effects

As described above, according to an embodiment of the present disclosure, it is possible to increase the convenience of safety management by conducting safety surveillance and patrol in the workplace which are conventionally performed by safety management personnel. Accordingly, discrepancies due to differences in the skill level of the safety management personnel may be resolved, and safety management is available at all times regardless of the working hours of the safety management personnel.

Furthermore, according to an embodiment of the present disclosure, it is possible to provide seamless communication connectivity between a management robot and a local controller by determining the location of a relay robot based on the location of the management robot.

Furthermore, according to an embodiment of the present disclosure, safety management using swarm robots is available at all times even in an industrial environment with no fixed-type charging infrastructure built in it, by including a charging robot as a mobile charging means.

### BRIEF DESCRIPTION OF DRAWINGS

FIG. 1 is a block diagram schematically showing a swarm robot control system according to an embodiment of the present disclosure.

FIG. 2 is a flowchart showing a method of selecting the location of a relay robot according to an embodiment of the present disclosure.

FIGS. 3A to 3C are exemplary views for explaining a method of selecting the location of a relay robot according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Furthermore, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

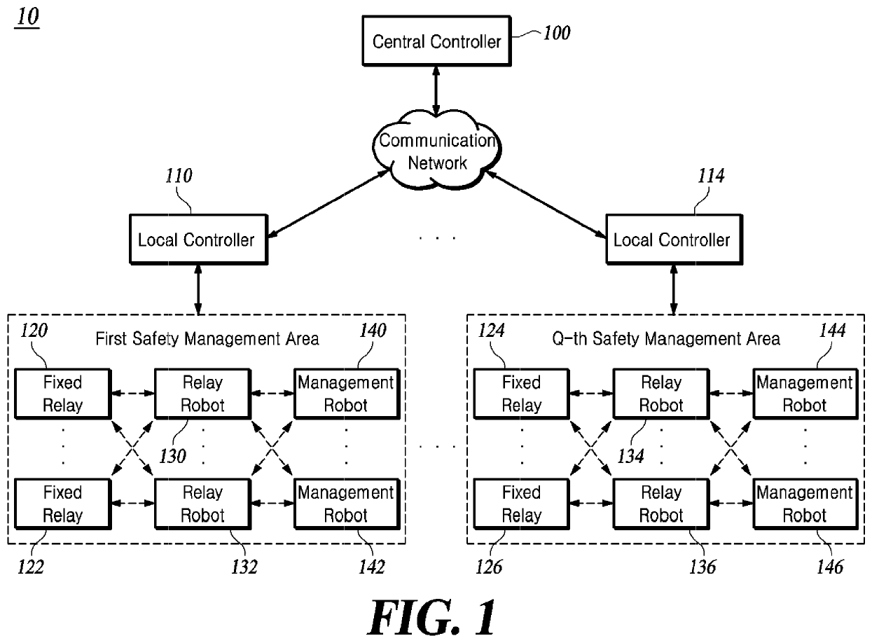

FIG. 1 is a block diagram schematically showing a swarm robot control system according to an embodiment of the present disclosure.

Referring to FIG. 1, a swarm robot control system 10 according to an embodiment of the present disclosure includes all or part of a central controller 100, at least one local controller 110 and 114, at least one fixed relay 120 to 126, at least one relay robot 130 to 136, and at least one management robot 140 to 146. It is to be noted that not all blocks illustrated in FIG. 1 are necessary components, and that some of the blocks included in the swarm robot control system 10 may be added, altered, or deleted in other embodiments. That is, FIG. 1 illustrates, by way of example, components required for the swarm robot control system 10 to control the relay robots 130 to 136 and/or the management robots 140 to 146 in each safety management area, and it should be appreciated that the swarm robot management system 10 may have more or fewer components or different components than those illustrated to implement other functions.

Hereinafter, in describing FIG. 1, swarm robots refer to all or part of the relay robots 130 to 136 and the management robots 140 to 146.

The central controller 100 remotely controls and manages swarm robots in each safety management area, collects and analyzes safety management data for each safety management area, and stores the safety management data in the central controller 100 or in a separately built safety management database. Here, the safety management data is data the management robots 140 to 146 collect while traveling in a particular safety management area. For example, it may include, but not limited to, hazardous gas concentrations, air quality information, temperatures, worker safety information and/or intruder information, and so on.

The central controller 100 according to an embodiment of the present disclosure may output safety management data on a monitor so that a manager in a control room can deal with dangerous situations. Also, upon a request from a manager terminal (not shown) outside the control room, safety management data may be sent to the manager terminal.

The central controller 100 according to an embodiment of the present disclosure transmits control command data and/or data necessary for autonomous traveling, for swarm robots in a particular safety management area, to the local controller 110 and 114 which is in charge of this safety management area. Here, the control command data is data for remotely controlling the platooning robot. For example, such data may include, but not limited to, static/dynamic real-time task assignment and deployment data including which tasks to assign to swarm robots and/or where to perform the tasks, command data for dealing with emergency situations, task synchronization data, and so on. The data necessary for autonomous traveling is data necessary for swarm robots to travel autonomously in a safety management area. For example, such data may include, but not limited to, initial workplace layout map data, dynamic/static obstacle data, environment model data, and sematic information.

The central controller 100 according to an embodiment of the present disclosure receives, from the local controller 110 and 114 in charge of a particular safety management area, safety management data, swarm robot data, and/or robot status data for this safety management area. Here, the swarm robot data is data showing a deployment of swarm robots in the safety management area. The robot status data is data showing the status of each robot in the safety management area, which may include, but not limited to, remaining battery level, sensor information, parts information, failure diagnosis information, temperature, humidity, and so on.

The central controller 100 according to an embodiment of the present disclosure may generate control command data based on collected swarm robot data and/or robot status data or receive control command data from the manager.

The central controller 100 may communicate with the local controller 110 and 114 placed in the safety management area via various forms of wired/wireless networks. For example, the central controller 100 may transmit and receive various types of data to and from the local controller 110 and 114 by using either a wireless communication scheme, which is implemented through Bluetooth Low Energy (BLE), wireless LAN, UWB (Ultra Wideband), radio frequency, Infrared Data Association (IrDA), Zigbee, or a cellular network, or a wired communication scheme, which is implemented through a wired telephone network or a wired internet telephone network.

The local controllers 110 and 114 are placed in a distributed manner in respective safety management areas and perform a function of relaying communication between the central controller 100 and swarm robots. Specifically, the local controllers 110 according to an embodiment of the present disclosure may transmit control command data and/or data necessary for autonomous traveling received from the central controller 100 to the swarm robots in the safety management area they are in charge of, and collect safety management data, swarm robot data, and/or robot status data for this safety management area and transmit it to the central controller 100.

The local controllers 110 and 114 according to another embodiment of the pre sent disclosure may generate control command data based on swarm robot data, robot status data, and/or on-site autonomous traveling data received from the swarm robots in the safety management area they are in charge of and transmit the command data to the swarm robots. Here, the on-site autonomous traveling data is map data that is updated in real time as the robots travel autonomously across the safety manage area.

The fixed relays 120 to 126 and the relay robots 130 to 136 are relay devices that are adopted to relay communication between the local controllers 110 and 114 and the management robots 140 to 146.

According to an embodiment of the present disclosure, one or more fixed relays 120 to 126 may be placed at a predetermined location in each safety management area.

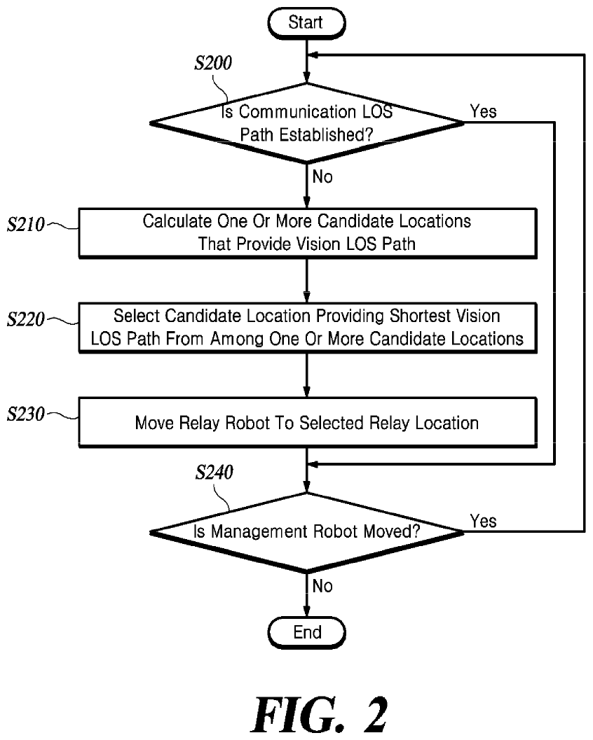

Meanwhile, according to another embodiment of the present disclosure, in a case where the fixed relays 120 to 126 cannot be installed in a safety management area, or in a case where communication between the relay controllers 110 and 114 and the management robots 140 and 146 is not made possible by the installation of the fixed relays 120 to 126 alone, the relay robots 130 to 136 may perform a function of relaying communication between the local controller 110 and the management robots 140 to 146. A concrete description of a method for determining a location where the relay robots 130 to 136 will move to relay communication will be given with reference to FIG. 2.

The relay robots 130 to 136 according to another embodiment of the present disclosure may provide the management robots 140 to 146 with a wired/wireless charging function as well as the communication relaying function. For example, the relay robots 130 to 136 may receive robot status data from the management robots 140 to 1246 and/or the local controllers 110 and 114 and move to where management robots 140 to 146 that need charging are located, and provide the management robots electric power for charging the batteries.

The management robots 140 to 146 are robots that travel autonomously in a safety management area and perform safety diagnosis and surveillance patrol based on data necessary for autonomous traveling and/or control command data received from the local controllers 110 and 114, and collect on-site autonomous traveling data and/or safety management data and transmit it to the local controllers 110 and 114.

The swarm robot control system 10 according to an embodiment of the present disclosure may further include a charging robot (not shown) which supports charging of the relay robots 130 to 136 and/or the management robots 140 to 146.

The charging robot according to an embodiment of the present disclosure provides a mobile charging means that can deal with an industrial environment where there is no fixed-type charging infrastructure. The charging robot is a robot that is equipped with a rechargeable battery and travels autonomously across each safety management area or the entire swarm robot control system regardless of location in order to support charging of the relay robots 130 to 136 and/or the management robots 140 to 146. For example, the charging robot may charge its rechargeable battery with line power and then stand by at a given spot within the safety management area or the entire swarm robot control system and then receive a call signal from other robots (e.g., a management robot or a relay robot) that need charging. The charging robot may move to a location corresponding to the received call signal, and provide the robot that has sent the call signal with electric power for wired/wireless charging.

While the above description has been made on the assumption that the relay robots 130 to 136, the management robots 140 to 146, and the charging robot are separate standalone devices, a single robot may perform two or more robot functions of the relay robots, the management robots, and the charging robot according to another embodiment of the present disclosure.

FIG. 2 is a sequential chart showing a method of selecting the location of a relay robot according to an embodiment of the present disclosure.

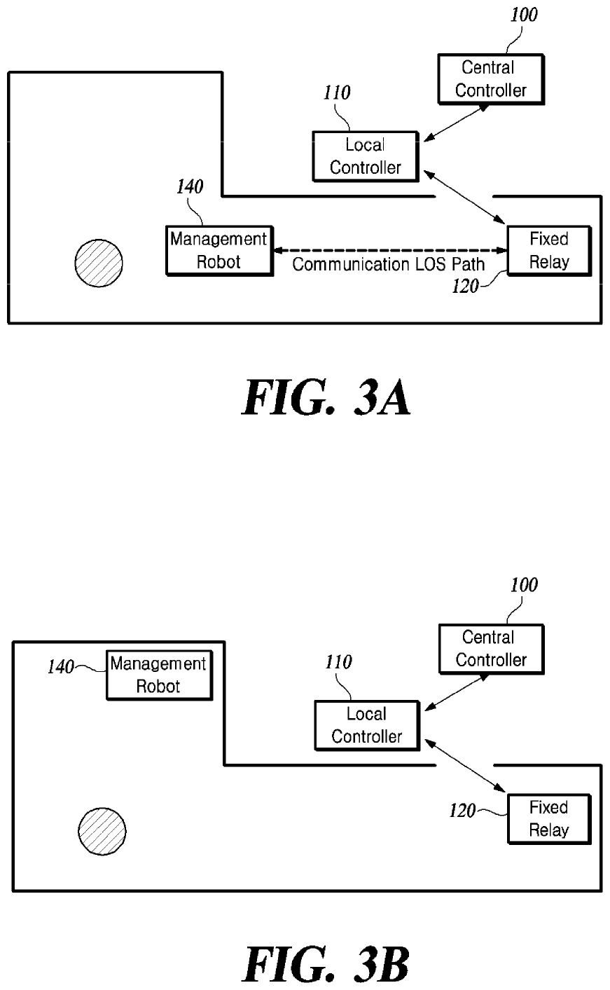

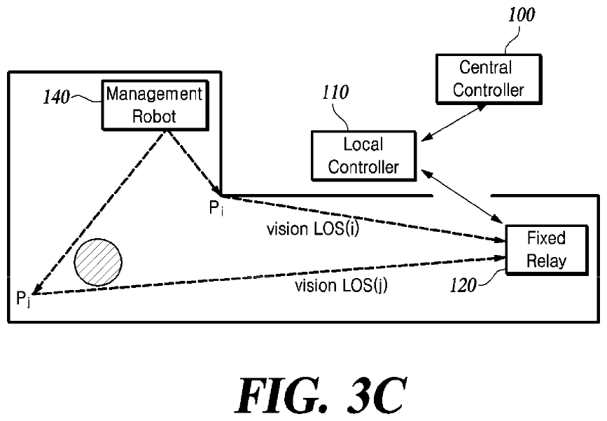

FIGS. 3A to 3C are exemplary views for explaining a method of selecting the location of a relay robot according to an embodiment of the present disclosure.

Although the following description will be given of a method of determining the location of a relay robot with respect to one local controller 110, one fixed relay 120, one relay robot 130, and one management robot 140, this is merely for illustration, and a method of determining the location of a relay robot according to an embodiment of the present disclosure also may be applicable to one or more management robots 140, one or more relay robots 130, and one or more fixed relays 120.

Meanwhile, although the following description will be given of an example in which the local controller 110 determines the location of the relay robot 130, this is merely an embodiment, and the central controller 100 may determine the location of the relay robot 130 or the relay robot 130 itself may determine its own location. To this end, the central controller 10 and/or the relay robot 130 may collect at least one of data necessary for autonomous traveling, on-site autonomous traveling data, and swarm robot data.

The local controller 110 checks whether a communication LOS (Line of Sight) path is established between the management robot 140 and either the fixed relay 120 or the local controller 110 (S200). FIG. 3A shows that the communication LOS path is established, and FIG. 3B shows that the communication LOS path is not established. For example, the local controller 110 is able to check whether the communication LOS path is established, depending on the success of communication with the management robot 140 or by using swarm robot data, but the present disclosure is not limited to this example.

When the communication LOS path is not established, the local controller 110 calculates one or more candidate locations that provide a vision LOS path through map matching (S210). Specifically, assuming that the relay robot 130 is to be placed in a safety management area, the local controller 110 calculates one or more candidate locations pₖ, where k is a natural number, by which the communication LOS path is established. The virtual communication LOS path established herein is referred to as a vision LOS path. FIG. 3C shows a vision LOS path established when it is assumed that the relay robot 130 is placed in an i-th candidate location pᵢ or a j-th candidate location pⱼ.

The local controller 110 selects a candidate location providing a shortest vision LOS path as a relay location pᵣ where the relay robot 130 is to be placed, from among one or more candidate locations (S220). This can be expressed by Equation 1:

$${p}_{r} = {min}_{\begin{matrix}\vert LOS ( k ) \vert \\ k = 1 , 2 , … , l\end{matrix}} \{ {p}_{k} \} \qquad Equation 1$$

wherein 1 is the number of candidate locations, and |LOS(k)| is the length of the vision LOS path corresponding to a candidate location pₖ.

The relay robot 130 moves to a selected relay location (S230). To this end, the local controller 110 according to an embodiment of the present disclosure may generate control command data and transmit it to the relay robot 130 in order for the relay robot 130 to move to the selected relay location.

The local controller 110 repeats the steps S200 through S230 once the location of the management robot 140 is changed (S240). That is, the relay location of the relay robot 130 is updated as the management robot moves, and therefore a seamless communication connection may be provided between the local controller 110 and the management robot 140 even if the location of the management robot 140 is changed.

Although FIG. 2 illustrates that the steps are sequentially performed, this is merely an illustration of the technical idea of an embodiment of the present disclosure. In other words, a person of ordinary skill in the art to which an embodiment of the present disclosure pertains may make various modifications and variations without departing from the essential characteristics of the present disclosure by changing the order described in FIG. 2 or executing one or more of the steps in parallel. Thus, FIG. 2 is not limited to a time-series order.

Various implementations of the systems and techniques described herein can be realized by digital electronic circuitry, integrated circuitry, FPGAs (field programmable gate arrays), ASICs (application specific integrated circuits), computer hardware, firmware, software, and/or combinations thereof. These various implementations can include implementation in one or more computer programs that are executable on a programmable system. The programmable system includes at least one programmable processor (which may be a special-purpose processor or a general-purpose processor) coupled to receive data and instructions from, and transmit data and instructions to, a storage system, at least one input device, and at least one output device. Computer programs (also known as programs, software, software applications or code) contain instructions for a programmable processor and are stored on a “computer-readable recording medium”.

The computer-readable recording medium includes all types of recording devices in which data readable by a computer system is stored. These computer-readable recording media may include non-volatile or non-transitory media, such as ROM, CD-ROM, magnetic tape, floppy disk, memory card, hard disk, magneto-optical disk, and storage device, and may further include transitory media such as data transmission media. In addition, the computer-readable recording medium may be distributed in network-connected computer systems, and computer-readable codes may be stored and executed in a distributed manner.

Various implementations of the systems and techniques described herein can be realized by a programmable computer. Here, the computer includes a programmable processor, a data storage system (including volatile memory, nonvolatile memory, or any other type of storage system or a combination thereof) and at least one communication interface. For example, the programmable computer may be one of a server, a network device, a set-top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### REFERENCE NUMERALS

10: swarm robot control system
100: central controller
110˜114: local controller
120˜126: fixed relay
130˜136: relay robot
140˜146: management robot

### CROSS-REFERENCE TO RELATED APPLICATION

The present application claims priority to Patent Application Number 10-2021-0018499, filed on Feb. 9, 2021 in Korea, and Patent Application Number 10-2021-0028589, filed on Mar. 4, 2021 in Korea, the disclosures of which are incorporated by reference herein in their entireties.

What is claimed is:

1. A swarm robot control system for safety diagnosis and surveillance patrol for each safety management area, the swarm robot control system comprising:
one or more management robots which are placed in each safety management area, and collect and transmit safety management data while traveling autonomously in a safety management area based on control command data;
a local controller which is placed in each safety management area, and transmits the control command data to the management robot and receives the safety management data from the management robot;
one or more relay robots which are placed in each safety management area, and move to a predetermined relay location so as to relay communication between the local controller and the management robot;
a charging robot which is equipped with a rechargeable battery, and provides power for charging the battery to at least one of the management robot or the relay robot; and
a central controller which receives the safety management data from the local controller in each safety management area and transmits the control command data to the local controller so as to remotely control the management robot.

2. The swarm robot control system of claim 1, wherein the relay location is updated as the management robot moves, and a candidate location providing a shortest LOS (Line of Sight) path is selected as the relay location from among one or more candidate locations providing an LOS between the management robot and the local controller.

3. The swarm robot control system of claim 2, wherein the relay location is updated as the management robot moves, when there is no LOS path established between the management robot and the local controller.

4. The swarm robot control system of claim 2, wherein the local controller is configured to:
collect map data of the safety management area and deployment data of the management robot,
calculate the one or more candidate locations based on the map data and the deployment data,
select the relay location from among the candidate locations, and
transmit the control command data to the relay robot in order for the relay robot to move to the relay location.

5. The swarm robot control system of claim 2, wherein the central controller is configured to:
receive deployment data of the management robot from the local controller,
calculate the one or more candidate locations based on the deployment data,
select the relay location from among the candidate locations, and
transmit the control command data to the local controller in order for the relay robot to move to the relay location.

6. The swarm robot control system of claim 2, wherein the relay robot is configured to:
receive deployment data of the management robot from the local controller,
calculate the one or more candidate locations based on the deployment data,
select the relay location from among the candidate locations, and
move to the relay location.

7. The swarm robot control system of claim 1, further comprising a fixed relay which is placed at a predetermined location in each safety management area, and relays communication between the management robot and the local controller,
wherein the relay location is updated as the management robot moves, and a candidate location providing a shortest LOS (Line of Sight) path is selected as the relay location from among one or more candidate locations providing an LOS between the management robot and the fixed relay.

8. The swarm robot control system of claim 1, wherein the charging robot is configured to:
receive a call signal from at least one of the management robot or the relay robot,
move to a location corresponding to the call signal, and
provide electric power to a robot that has sent the call signal.

9. An operation method of a swarm robot control system including a management robot, a relay robot, a local controller, and a central controller, the operation method comprising:
collecting, by the management robot, safety management data while the management robot travels autonomously in a safety management area based on control command data received from the local controller;
selecting, by the relay robot, a relay location based on the location of the management robot;
relaying, by the relay robot, communication between the local controller and the management robot after moving to the relay location; and
receiving, by the local controller, the safety management data from the management robot and transmitting the safety management data to the central controller.

10. The method of claim 9, wherein the selecting of the relay location includes:
checking whether a communication LOS (Line of Sight) path is established between the management robot and either the local controller or a fixed relay placed at a predetermined location in the safety management area;
when no LOS path is established, calculating one or more candidate locations providing an LOS path between the management robot and either the local controller or the fixed relay; and
selecting a candidate location providing a shortest LOS path as the relay location from among the one or more candidate locations.
